(19) United States
(12) Patent Application Publication
(10) Pub. No.: US 2013/0166452 A1
(43) Pub. Date: Jun. 27, 2013

(54) PAYMENT APPARATUS AND METHOD USING PORTABLE TERMINAL IN BROADCASTING RECEIVER

(71) Applicant: SAMSUNG ELECTRONICS CO., LTD, Gyeonggi-do (KR)

(72) Inventors: Sung-Yoon Song, Seoul (KR); Cheol-Ju Hwang, Gyeonggi-do (KR); Seong-Woon Kang, Gyeonggi-do (KR)

(73) Assignee: SAMSUNG ELECTRONICS CO., LTD, Gyeonggi-do (KR)

(21) Appl. No.: 13/725,873

(22) Filed: Dec. 21, 2012

(30) Foreign Application Priority Data
Dec. 22, 2011 (KR) 1020110140131

(51) Int. Cl. G06Q 20/40

(52) U.S. Cl. CPC G06Q 20/40
USPC 705/44

(57) ABSTRACT

A method of operating a broadcasting receiver for payment. The method includes extracting an identifier code that is being displayed, receiving payment information matching to the identifier code from a portable terminal, and combining information extracted from the identifier code with the payment information and requesting payment approval to a payment service provider.

### CROSS-REFERENCE TO RELATED APPLICATION(S) AND CLAIM OF

The present application is related to and claims the benefit under 35 U.S.C. §119(a) to a Korean Patent Application filed in the Korean Intellectual Property Office on Dec. 22, 2011 and assigned Serial No. 10-2011-0140131, the entire disclosure of which are hereby incorporated by reference.

### TECHNICAL FIELD OF THE INVENTION

The present disclosure relates to a payment apparatus and method using a portable terminal in a broadcasting receiver.

### BACKGROUND OF THE INVENTION

With the development of an information technology, users became able to, as subjects, select several media in an active fashion from the age that a multimedia medium had simply provided a video to the users in a passive fashion. For example, a multitasking function of enabling a user to view a movie while simultaneously accessing the Internet to search information is being commercialized.

Even devices receiving a broadcast signal and providing a video to users are developing rapidly. It's typical example can be a television commonly encountered at a home, a restaurant, a public place and the like. The television not only provides a variety of information to users but also improves the convenience of sellers and the users as specialized channels are newly established such as an online shopping channel, a home shopping channel and the like.

But, even when the user views broadcasting while encountering goods or service of usual interest through the broadcasting such as the aforementioned home shopping, it is cumbersome to purchase the goods or service of interest. For instance, to purchase goods of interest, a user has to suffer an inconvenience of picking up the receiver to make a call with a counselor, or accessing a home page of a seller side over the Internet to input payment information himself/herself.

Accordingly, there is a need for the urgent development of a method for enabling a user to easily purchase goods of interest at the same time of watching television.

### SUMMARY OF THE INVENTION

To address the above-discussed deficiencies of the prior art, it is a primary object to provide at least the advantages below. Accordingly, one aspect of the present disclosure is to provide a payment apparatus and method for, during television watching, promptly purchasing goods or service of interest using a portable terminal having a function of a card reader.

Another aspect of the present disclosure is to provide a payment apparatus and method for enabling encrypted short-range communication between a server and a television, and protecting user's personal information.

A further aspect of the present disclosure is to provide an apparatus and method for extracting information of a goods or service code that is being displayed on a television, and promptly paying goods of user's interest.

The above aspects are achieved by providing a payment apparatus and method using a portable terminal in a broadcasting receiver.

According to one aspect of the present disclosure, an operation method of a broadcasting receiver for payment is provided. The method includes extracting an identifier code that is being displayed, receiving payment information matching to the identifier code from a portable terminal, and combining information extracted from the identifier code with the payment information and requesting payment approval to a payment service provider.

According to another aspect of the present disclosure, an operation method of a broadcasting receiver for payment is provided. The method includes receiving payment information from a card, and transmitting the received payment information to a broadcasting receiver.

The method further includes receiving an input of a key from a user, generating a payment signal according to the input of the key and transmitting the generated payment signal to the broadcasting receiver.

In an exemplary embodiment of the present disclosure, the payment signal is a signal for extracting the identifier code by the broadcasting receiver to purchase goods or service associated with a broadcasted of the broadcasting receiver.

In an exemplary embodiment of the present disclosure, the identifier code is a goods or service code that is being displayed in any region of the broadcasting receiver.

In an exemplary embodiment of the present disclosure, the goods or service code comprises at least One of a character code, an image code, a quick response (QR) code, and a bar code.

In an exemplary embodiment of the present disclosure, the payment information comprises card information of a user who performs short-range communication using the portable terminal.

In an exemplary embodiment of the present disclosure, transmitting the payment information to the broadcasting receiver comprises performing encrypted short-range communication with the broadcasting receiver.

According to another aspect of the present disclosure, an operation method of a broadcasting receiver for payment is provided. The method includes receiving a specific code from a broadcasting receiver, analyzing the received specific code and transmitting detailed information matching the specific code to the broadcasting receiver.

In an exemplary embodiment of the present disclosure, the specific code is a goods or service code extracted, in the broadcasting receiver, from an identifier code that is being displayed in a region of the broadcasting receiver.

In an exemplary embodiment of the present disclosure, the detailed information comprises at least one of a price of goods or service matching to a goods or service code received from the broadcasting receiver, a quantity, a sale period, and a discount condition.

The method further includes receiving a payment approval result from a payment service provider and transmitting the received payment approval result to the broadcasting receiver.

According to another aspect of the present disclosure, an apparatus of a broadcasting receiver for payment is provided. The apparatus includes a controller and a communication unit. The controller extracts an identifier code that is being displayed. The communication unit receives payment information matching to the identifier code from a portable terminal, combines information extracted from the identifier code with the payment information, and requests payment approval to a payment service provider.

According to another aspect of the present disclosure, an apparatus of a broadcasting receiver for payment is provided. The apparatus includes a controller configured to control to receive payment information from a card and a communication module configured to receive the payment information from the card and transmit the received payment information to a broadcasting receiver.

The apparatus includes further a display unit for receiving an input of a key from a user. The controller is configured to generate a payment signal according to the input of the key and the communication module is configured to transmit the generated payment signal to the broadcasting receiver.

In an exemplary embodiment of the present disclosure, the payment signal is a signal for extracting the identifier code by the broadcasting receiver to purchase goods or service associated with a broadcast of the broadcasting receiver.

In an exemplary embodiment of the present disclosure, the identifier code is a goods or service code that is being displayed in any region of the broadcasting receiver.

In an exemplary embodiment of the present disclosure, the goods or service code comprises at least one of a character code, an image code, a quick response (QR) code, and a bar code.

In an exemplary embodiment of the present disclosure, the payment information comprises card information of a user who performs short-range communication using the portable terminal.

In an exemplary embodiment of the present disclosure, the communication module is configured to perform encrypted short-range communication with the broadcasting receiver.

According to another aspect of the present disclosure, an apparatus of a broadcasting receiver for payment is provided. The apparatus includes a controller configured to analyze a specific code received from a broadcasting receiver and a communication module configured to transmit detailed information matching the specific code to the broadcasting receiver.

In an exemplary embodiment of the present disclosure, the specific code is a goods or service code extracted, in the broadcasting receiver, from an identifier code that is being displayed in a region of the broadcasting receiver.

In an exemplary embodiment of the present disclosure, the detailed information comprises at least one of a price of goods or service matching to a goods or service code received from the broadcasting receiver, a quantity, a sale period, and a discount condition.

In an exemplary embodiment of the present disclosure, the communication module is configured to receive a payment approval result from a payment service provider, and transmit the received payment approval result to the broadcasting receiver.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system for purchasing goods of interest using a portable terminal according to an exemplary embodiment of the present disclosure;

FIG. 2 illustrates a process of purchasing goods of interest using a portable terminal according to an exemplary embodiment of the present disclosure;

FIG. 3 illustrates a method of operating a television according to an exemplary embodiment of the present disclosure;

FIG. 4 illustrates a method of operating a server according to an exemplary embodiment of the present disclosure;

FIG. 5 illustrates a method of operating a portable terminal according to the present disclosure;

FIG. 6 illustrates a block diagram of a television according to an exemplary embodiment of the present disclosure;

FIG. 7 illustrates a block diagram of a server according to an exemplary embodiment of the present disclosure; and

FIG. 8 illustrates a block diagram of a portable terminal according to the present disclosure.

### DETAILED DESCRIPTION OF THE INVENTION

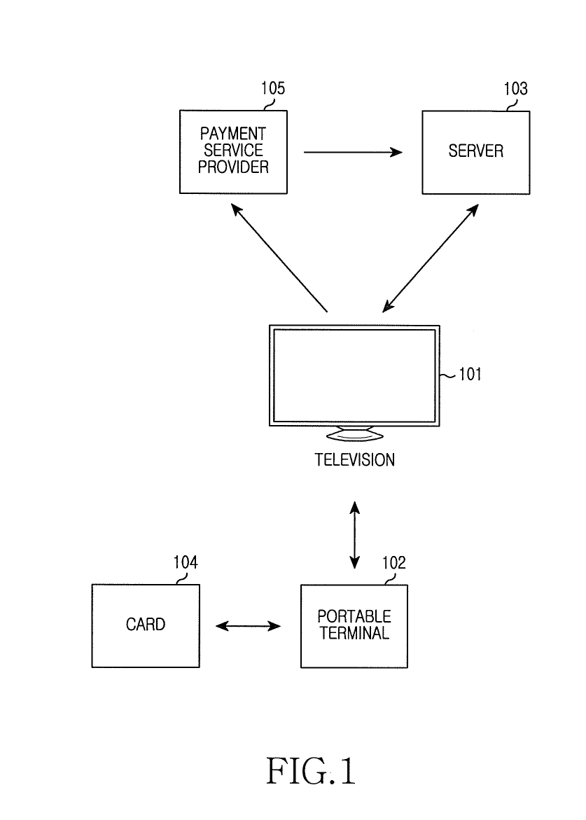

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Preferred embodiments of the present disclosure will be described herein below with reference to the accompanying drawings. In the following description, well-known functions or constructions are not described in detail since they would obscure the disclosure in unnecessary detail. Also, parts performing like function and operations are denoted by the same symbols throughout the drawings.

FIG. 1 illustrates a system for purchasing goods of interest using a portable terminal according to an exemplary embodiment of the present disclosure.

As illustrated in FIG. 1, a television 101 refers to a device receiving broadcasting and providing a video. In FIG. 1, the television 101 is illustrated, but, if any device makes possible broadcasting reception and video provision, it can replace the television 101. In the present disclosure, the television 101 receives a payment signal from a portable terminal 102, and extracts an identifier code that is currently being displayed in the television 101. Here, the payment signal is defined as a signal for extracting the identifier code by the television 101 in order for a user to purchase goods or service that is being broadcasted in the television 101. In detail, in an example where the user now desires to purchase the goods or service that is being broadcasted in the television 101, he/she declares his/her purchase intention through the portable terminal 102. This purchase intention is called the payment signal. Also, the identifier code is defined as a code for goods or service displayed in any region of the television 101. In detail, when broadcasting home shopping programs, a home shopping broadcaster transmits, together with a broadcasting screen, a code for goods or service that is being currently broadcasted in any region of the broadcasting screen. This identifier code is expressed in a form of any one of a character code, an image code, a quick response (QR) code, and a bar code, and contains information on goods. If the television 101 receives the payment signal from the portable terminal 102, the television 101 extracts the identifier code from a screen that is currently being displayed, and transmits the extracted goods or service code to a server 103. After that, the television 101 receives detailed information on the goods or service from the server 103. Here, the detailed information on the goods or service refers to information including at least one of a price of goods or service selected by a user, a quantity, a sale period, and a discount condition. The television 101 receiving the detailed information from the server 103 again receives payment information from the portable terminal 102, combines the aforementioned detailed information with the payment information, and requests payment approval to a payment service provider 105. Next, the television 101 receives the payment approval result from the server 103, and displays the payment approval result so that the user can check the payment approval result.

The portable terminal 102 refers to a device for performing a contact or non-contact communication function with a user's card. For example, the portable terminal 102 can be a remote controller of the television 101, a mobile phone or the like. In detail, when the television 101 broadcasts home shopping programs, the portable terminal 102 receives an input of a payment button from a user and generates a payment signal. The payment signal generated in the portable terminal 102 is transmitted to the television 101, allowing the television 101 to extract an identifier code that is being currently displayed. After that, the portable terminal 102 receives payment information from a card 104, and transmits the received payment information to the television 101. Here, the payment information refers to information of a user's card performing short-range communication with the portable terminal 102. In detail, in the present disclosure, the portable terminal 102 can perform the short-range communication with the card 104 and promptly read out the user's card information. That is, in the conventional art, a user had to access a corresponding home page himself/herself or use a phone to purchase goods of interest during home shopping broadcasting. But, in the present disclosure, if the user brings the card 104 into contact with the portable terminal 102, the portable terminal 102 and the card 104 can perform the short-range communication, promptly making payment.

The server 103 transmits detailed information on goods or service selected by a user, to the television 101. Also, the server 103 receives the payment approval result from the payment service provider 105 and transmits the payment approval result to the television 101. In detail, the server 103 receives a goods or service code extracted by the television 101, from the television 101, and extracts the detailed information stored in the server 103. That is, detailed information on specific goods or service has been stored in the server 103. As described above, if receiving a specific goods or service code from the television 101, the server 103 extracts detailed information matching to the received code. If extracting the detailed information, the server 103 transmits the extracted detailed information to the television 101. Next, if notified the payment approval result from the payment service provider 105, the server 103 transmits the notified payment approval result to the television 101.

The user's card 104 is a card having a contact or non-contact communication function with the portable terminal 101. In detail, the user's card 104 can be built in the portable terminal 101, or can be a plastic Integrated Circuit (IC) card supporting Near Field Communication (NFC) such as MiFare and Felica and Radio Frequency (RF) communication or a mobile card. In the present disclosure, when the user intends to purchase interest goods that are being broadcasted, he/she can get the user's card 104 to connect to the portable terminal 102, promptly making payment.

The payment service provider 105 notifies the server if a payment method presented by a user is acceptable. For example, the payment service provider 105 can be a card company, a bank company, a telecommunication company and the like. In the present disclosure, the payment service provider 105 receives a payment approval request from the television 101, makes payment, and notifies the server 103 of the payment approval result.

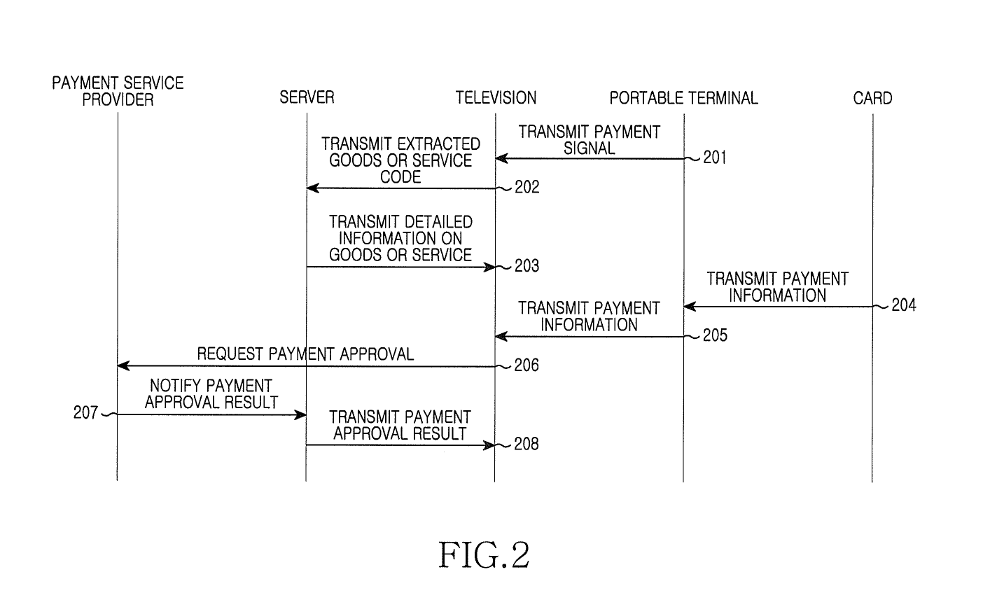

FIG. 2 illustrates a process of purchasing goods of interest using a portable terminal according to an exemplary embodiment of the present disclosure.

As illustrated in FIG. 2, the portable terminal transmits a payment signal to a television (step 201). For example, assume that a user is watching home shopping broadcasting through the television. The user who is watching the home shopping broadcasting checks that goods of usual interest are being sold, and presses a payment button on the portable terminal to purchase the interest goods. That is, the portable terminal receives an input of the payment button from the user, and generates the payment signal. Here, the payment signal is defined as a signal for extracting an identifier code by the television in order for the user to purchase goods or service that is being broadcasted in the television. In detail, in an example where the user now desires to purchase the goods or service that is being broadcasted in the television, he/she declares his/her purchase intention through the portable terminal. This purchase intention is called the payment signal.

The television receiving the payment signal from the portable terminal transmits an extracted goods or service code to a server (step 202). In detail, a home shopping broadcaster transmits a screen together with home shopping broadcasting including the identifier code. That is, when the home shopping broadcasting is aired in the television, even the identifier code is displayed together in any region of the television. Here, the identifier code is defined as a code for goods or service displayed in any region of the television. In detail, when broadcasting home shopping programs, the home shopping broadcaster transmits, together with a broadcasting screen, a code for goods or service that is being currently broadcasted in any region of the broadcasting screen. This identifier code is expressed in a form of any one of a character code, an image code, a QR code, and a bar code, and contains information on goods. In addition, the identifier code can include even a code that is not displayed on a screen of the television using the digital watermarking technology. The television receiving the payment signal from the portable terminal extracts the identifier code that is currently included in the screen of the television, and transmits the extracted goods or service code to the server.

The server receiving the extracted goods or service code from the television again transmits detailed information on goods or service to the television (step 203). In detail, the server has stored detailed information of all registered goods or services. That is, the server receives the goods or service code extracted by the television, extracts the detailed information on the goods or service matching to the received code, and transmits the extracted detailed information to the television. Here, the detailed information refers to information including at least one of a price of goods or service selected by a user, a quantity, a sale period, and a discount condition. Desirably, when a home shopping broadcaster first transmits a screen together with home shopping broadcasting including an identifier code, if data of the aforementioned detailed information is less, the server may include the detailed information in the identifier code. That is, in an example of extracting an identifier code in the television, the server may promptly extract detailed information including at least one of a price of goods or service selected by a user, a quantity, a sale period, and a discount condition. Therefore, the aforementioned steps 202 and 203 may be omitted in some embodiments.

After that, payment information of the card is transmitted to the portable terminal through contact or non-contact communication between the card and the portable terminal (step 204). The user's card is a card having a contact or non-contact communication function with the portable terminal. In detail, the user's card can be built in the portable terminal, or can be a plastic IC card supporting NFC such as MiFare and Felica and RF communication or a mobile card. Also, the payment information refers to information of the user's card performing a short-range communication with the portable terminal. In detail, in the present disclosure, the portable terminal can perform the short-range communication with the card and promptly read out the user's card information. That is, in the conventional art, a user had to access a corresponding home page himself/herself or use a phone to purchase goods of interest during home shopping broadcasting. But, in the present disclosure, if the user brings the card into contact with the portable terminal, the portable terminal and the card can perform the short-range communication, promptly making payment.

The portable terminal receiving the payment information from the card transmits the received payment information to the television (step 205). In detail, the portable terminal and the television can connect with each other by a short-range communication such as Bluetooth, Wireless Fidelity (WiFi), Zigbee and the like. Particularly, for fear personal information such as user payment information can be exposed to the external, the present disclosure transmits the payment information from the portable terminal to the television through an encrypted wireless connection section. For example, in an example of using the Bluetooth among the short-range communications, a password is set between the television and the portable terminal so that user's personal information can be protected.

The television receiving the payment information from the portable terminal requests payment approval to a payment service provider (step 206). In detail, the television combines the payment information received from the portable terminal with the detailed information on the goods or service received from the server and requests the payment approval to the payment service provider. Desirably, when the television requests the payment approval to the payment service provider, the television encrypts this to prevent payment information exposure to the external.

The payment service provider receiving the payment approval request from the television again notifies the server of the payment approval result (step 207). The payment service provider notifies the server if a payment method presented by a user is acceptable. For example, the payment service provider can be a card company, a bank company, a telecommunication company and the like. In the present disclosure, the payment service provider receives a payment approval request from the television, makes payment, and notifies the server of the payment approval result.

The server notified the payment approval result from the payment service provider transmits the notified payment approval result to the television (step 208). In detail, the television is notified of the payment approval result from the server and displays the payment approval result on a screen of the television. For example, the payment approval result can include a message that payment of goods purchased by a user has been checked, or can include a delivery date of purchased goods, discount application or non-application, saved money (e.g., a discount) and the like. Therefore, the user can check the payment or non-payment of his/her own purchased goods through the television.

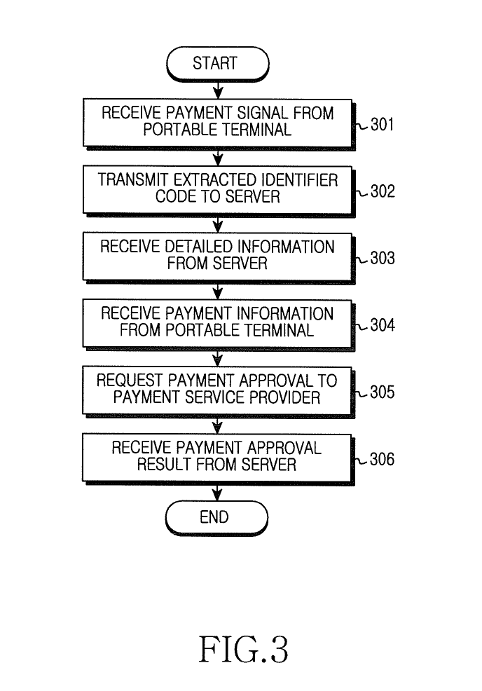

FIG. 3 illustrates a method of operating a television according to an exemplary embodiment of the present disclosure.

As illustrated in FIG. 3, the television receives a payment signal from a portable terminal (step 301). Here, the payment signal is defined as a signal for extracting an identifier code by the television in order for a user to purchase goods or service that is being broadcasted in the television. In detail, in an example where the user now desires to purchase the goods or service that is being broadcasted in the television, he/she declares his/her purchase intention through the portable terminal. This purchase intention is called the payment signal.

The television receiving the payment signal from the portable terminal transmits the extracted identifier code to a server (step 302). A home shopping broadcaster transmits a screen together with home shopping broadcasting including the identifier code. That is, when the home shopping broadcasting is aired in the television, even the identifier code is displayed together in any region of the television. Here, the identifier code is defined as a code for goods or service displayed in any region of the television. In detail, when broadcasting home shopping programs, the home shopping broadcaster transmits, together with a broadcasting screen, a code for goods or service that is being currently broadcasted in any region of the broadcasting screen. This identifier code is expressed in a form of any one of a character code, an image code, a QR code, and a bar code, and contains information on goods. In addition, the identifier code can include even a code that is not displayed on a screen of the television using the digital watermarking technology. The television receiving the payment signal from the portable terminal extracts the identifier code that is currently included in the screen of the television, and transmits the extracted goods or service code to the server.

The television transmitting the identifier code to the server receives, thereafter, detailed information from the server (303). In detail, the server has stored detailed information of all registered goods or services. That is, the server receives the goods or service code extracted by the television, extracts the detailed information on the goods or service matching to the received code, and transmits the extracted detailed information to the television. Here, the detailed information refers to information including at least one of a price of goods or service selected by a user, a quantity, a sale period, and a discount condition. Desirably, when a home shopping broadcaster first transmits a screen together with home shopping broadcasting including an identifier code, if data of the aforementioned detailed information is less, the server may include the detailed information in the identifier code. That is, in an example of extracting an identifier code in the television, the server may promptly extract detailed information including at least one of a price of goods or service selected by a user, a quantity, a sale period, and a discount condition. Therefore, the aforementioned steps 302 and 303 may be omitted in some embodiments.

The television receiving the detailed information from the server receives payment information from the portable terminal (step 304). Here, the payment information refers to information of the user's card performing a short-range communication with the portable terminal. In detail, in the present disclosure, the portable terminal can perform the short-range communication with the card and promptly read out the user's card information. That is, in the conventional art, a user had to access a corresponding home page himself/herself or use a phone to purchase goods of interest during home shopping broadcasting. But, in the present disclosure, if the user brings the card into contact with the portable terminal, the portable terminal and the card can perform the short-range communication, promptly making payment.

The television receiving the payment information from the portable terminal requests payment approval to a payment service provider (step 305). In detail, the television combines the payment information received from the portable terminal with the detailed information on the goods or service received from the server and requests the payment approval to the payment service provider. Desirably, when the television requests the payment approval to the payment service provider, the television encrypts this to prevent payment information exposure to the external.

After that, if the television receives the payment approval result from the server, the operation method of the television according to the present disclosure is terminated (step 306). In detail, the television is notified of the payment approval result from the server and displays the payment approval result on a screen of the television. For example, the payment approval result can include a message that payment of goods purchased by a user has been checked, or can include a delivery date of purchased goods, discount application or non-application, saved money (e.g., a discount) and the like. Therefore, the user can check the payment or non-payment of his/her own purchased goods through the television.

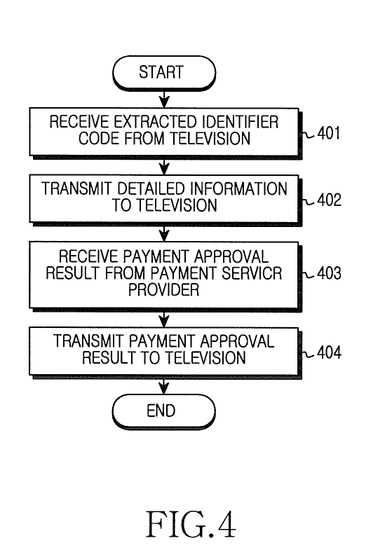

FIG. 4 illustrates a method of operating a server according to an exemplary embodiment of the present disclosure.

As illustrated in FIG. 4, the server receives an extracted identifier code from a television (step 401). In detail, the extracted identifier code contains information on goods or service. That is, the server receives the identifier code from the television, and extracts detailed information on goods or service matching to the received identifier code. For example, the server receiving a specific identifier code from the television reads the identifier code, and extracts detailed information matching to the identifier code, having been previously stored in the server.

The server receiving the identifier code from the television extracts detailed information matching to the identifier code and again transmits the detailed information to the television (step 402). Here, the detailed information refers to information including at least one of a price of goods or service selected by a user, a quantity, a sale period, and a discount condition. Desirably, when a home shopping broadcaster first transmits a screen together with home shopping broadcasting including an identifier code, if data of the aforementioned detailed information is less, the server may include the detailed information in the identifier code. That is, in an example of extracting an identifier code in the television, the server may promptly extract detailed information including at least one of a price of goods or service selected by a user, a quantity, a sale period, and a discount condition. Therefore, the aforementioned steps 401 and 402 may be omitted in some embodiments.

After that, the server receives the payment approval result from a payment service provider (step 403). In detail, if the television requests payment approval to the payment service provider, the payment service provider makes payment and notifies the server of the payment approval result. This payment approval result is received by the server from the payment service provider.

The server receiving the payment approval result from the payment service provider transmits the payment approval result to the television (step 404). That is, the server is notified the payment approval result from the payment service provider, and again notifies the television of the notified payment approval result. If the server transmits the payment approval result to the television, the operation of the server for payment is all terminated.

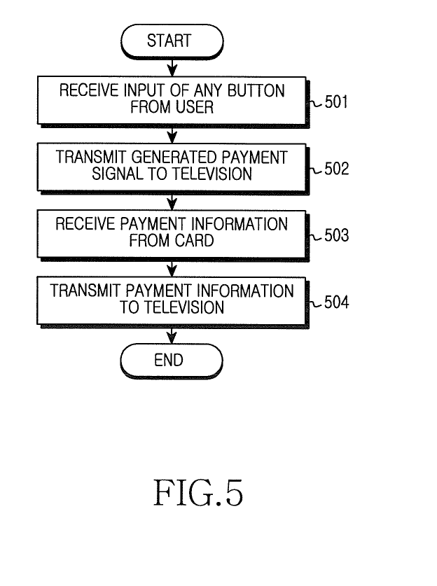

FIG. 5 illustrates a method of operating a portable terminal according to the present disclosure.

As illustrated in FIG. 5, the portable terminal receives an input of any button from a user (step 501). Here, the any button refers to a payment button and it is assumed that the user is watching home shopping broadcasting through the television, for example. The user who is watching the home shopping broadcasting checks that goods of usual interest are being sold, and presses the payment button on the portable terminal to purchase the interest goods. That is, the portable terminal receives an input of the payment button from the user.

The portable terminal receiving the input of the payment button transmits a generated payment signal to the television (step 502). That is, the portable terminal receives the input of the payment button from the user and generates the payment signal. Here, the payment signal is defined as a signal for extracting an identifier code by the television in order for the user to purchase goods or service that is being broadcasted in the television. In detail, in an example where the user now desires to purchase the goods or service that is being broadcasted in the television, he/she declares his/her purchase intention through the portable terminal. This purchase intention is called the payment signal.

The portable terminal transmitting the generated payment signal to the television receives payment information from a card (step 503). The user's card is a card having a contact or non-contact communication function with the portable terminal. In detail, the user's card can be built in the portable terminal, or can be a plastic IC card supporting NFC such as MiFare and Felica and RF communication or a mobile card. Also, the payment information refers to information of the user's card performing a short-range communication with the portable terminal. In detail, in the present disclosure, the portable terminal can perform the short-range communication with the card and promptly read out the user's card information. That is, in the conventional art, a user had to access a corresponding home page himself/herself or use a phone to purchase goods of interest during home shopping broadcasting. But, in the present disclosure, if the user brings the card into contact with the portable terminal, the portable terminal and the card can perform the short-range communication, promptly making payment.

The portable terminal receiving the payment information from the user's card transmits the received payment information to the television (step 504). In detail, the portable terminal and the television can connect with each other by a short-range communication such as Bluetooth, WiFi, Zigbee and the like. Particularly, for fear personal information such as user payment information can be exposed to the external, the present disclosure transmits the payment information from the portable terminal to the television through an encrypted wireless connection section. For example, in an example of using the Bluetooth among the short-range communications, a password is set between the television and the portable terminal so that user's personal information can be protected. If the portable terminal transmits the payment information to the television, the operation method of the portable terminal for payment is all terminated.

The method described above in relation with FIG. 5 under of the present invention may be provided as one or more instructions in one or more software modules, or computer programs stored in an electronic device including a portable terminal.

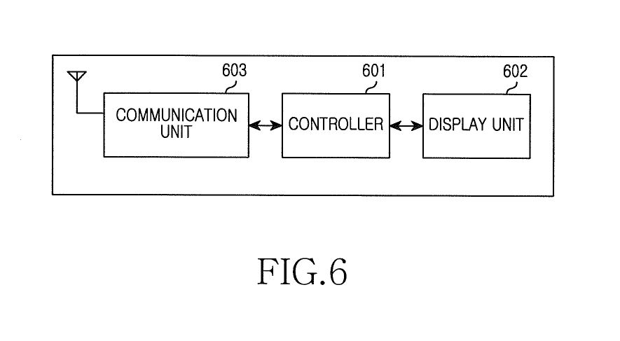

FIG. 6 illustrates a block diagram of a television according to an exemplary embodiment of the present disclosure.

As illustrated in FIG. 6, the television according to the present disclosure can include a controller 601, a display unit 602, and a communication unit 603.

The controller 601 controls the general operation of the television. For example, the controller 601 extracts an identifier code that is being displayed.

The display unit 602 displays state information of the television, a menu screen, and story information according to the control of the controller 601. For instance, the display unit 601 displays detailed information, and displays the payment approval result.

The communication unit 603 processes a signal transmitted/received through an antenna for voice and data communication. For example, the communication unit 603 receives payment information matching to an identifier code from the portable terminal, combines information extracted from the identifier code with payment information, and requests payment approval to a payment approval provider. Also, the communication unit 603 receives a payment signal from the portable terminal. Also, the communication unit 603 extracts an identifier code, transmits the extracted goods or service code to the server, and receives detailed information on goods or service from the server. Also, the communication unit 603 performs encrypted short-range communication with the portable terminal. Also, the communication unit 603 receives the payment approval result from the server.

In the aforementioned construction, the controller 601 can perform the general function of the television. In the present disclosure, these are separately constructed and shown in order to distinguish and describe respective functions. Thus, when a product is actually realized, construction can be such that the controller 601 can process all of the functions of the television, or construction can be such that the controller 601 may process only some of the functions.

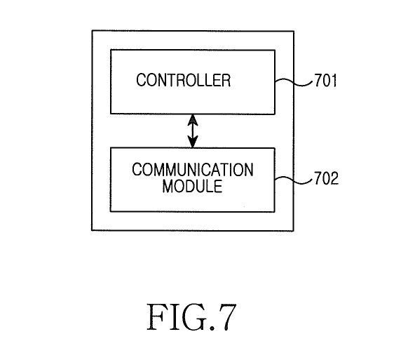

FIG. 7 illustrates a block diagram of a server according to an exemplary embodiment of the present disclosure.

As illustrated in FIG. 7, the server according to the present disclosure can include a controller 701 and a communication module 702.

The controller 701 controls the general operation of the server. For example, the controller 701 analyzes a specific code received from a broadcasting receiver.

The communication module 702 processes a signal transmitted/received through an antenna for voice and data communication. For example, the communication module 702 transmits detailed information matching to a specific code, to the broadcasting receiver. Also, the communication module 702 receives the payment approval result from a payment service provider, and transmits the received payment approval result to the broadcasting receiver.

In the aforementioned construction, the controller 701 can perform the general function of the server. In the present disclosure, these are separately constructed and shown in order to distinguish and describe respective functions. Thus, when a product is actually realized, construction can be such that the controller 701 can process all of the functions of the server, or construction can be such that the controller 701 may process only some of the functions.

The present invention may be implemented in an electronic device including a portable terminal such as, for example, a smart phone and a mobile telecommunication terminal. Hereunder, a portable terminal is used as an example for the electronic device.

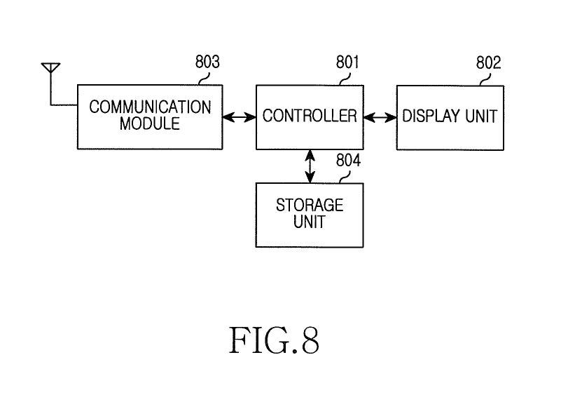

FIG. 8 illustrates a block diagram of a portable terminal according to the present disclosure.

As illustrated in FIG. 8, the portable terminal according to the present disclosure can include a controller 801, a display unit 802, a communication module 803, and a storage unit 804.

The controller 801 controls the general operation of the portable terminal. For example, the controller 801 receives payment information from a card, receives an input of a key from a user, and generates a payment signal.

The display unit 802 displays state information of the portable terminal, a menu screen, and story information. For example, the display unit 802 receives an input of any key from a user. Here, the any key refers to a payment signal that is intention of purchasing interest goods that the user desires to purchase.

The communication module 803 processes a signal transmitted/received through an antenna for voice and data communication. For example, the communication module 803 receives payment information from a card, and transmits the payment information to a broadcasting receiver. Also, the communication module 803 transmits a generated payment signal to the broadcasting receiver, and performs encrypted short-range communication with the broadcasting receiver.

The storage unit 804 can be composed of a program storage unit for storing a program for controlling an operation of the portable terminal and a data storage unit for storing data generated during the execution of a program.

In the aforementioned construction, the controller 801 can perform the general function of the portable terminal. In the present disclosure, these are separately constructed and shown in order to distinguish and describe respective functions. Thus, when a product is actually realized, construction can be such that the controller 801 can process all of the functions of the portable terminal, or construction can be such that the controller 801 may process only some of the functions.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of operating a broadcasting receiver for payment, the method comprising:
extracting an identifier code that is being displayed;
receiving payment information matching the identifier code from a portable terminal;
combining information extracted from the identifier code with the payment information; and
sending a request for payment approval to a payment service provider.

2. The method of claim 1, further comprising receiving a payment signal from the portable terminal.

3. The method of claim 2, wherein the payment signal is a signal for extracting the identifier code to purchase goods or service associated with a broadcast of the broadcasting receiver, and
wherein the identifier code is a goods or service code that is being displayed in a region of the broadcasting receiver.

4. The method of claim 3, wherein the goods or service code comprises at least one of a character code, an image code, a quick response (QR) code, and a bar code.

5. The method of claim 3 further comprising:
transmitting the goods or service code to a server;
receiving detailed information on goods or service from the server; and
displaying the detailed information.

6. The method of claim 1, wherein receiving the payment information matching to the identifier code from the portable terminal comprises performing encrypted short-range communication between the broadcasting receiver and the portable terminal.

7. The method of claim 7, wherein the payment information comprises card information of a user who performs the encrypted short-range communication using the portable terminal.

8. The method of claim 1, wherein the information extracted from the identifier code is detailed information on goods or service matching to the identifier code.

9. The method of claim 9, wherein the detailed information on the goods or service comprises at least one of a price of the goods or service, a quantity, a sale period, and a discount condition.

10. The method of claim 1 further comprising:
receiving the payment approval result from a server; and
displaying the payment approval result.

11. An apparatus of a broadcasting receiver for payment, the apparatus comprising:
a controller configured to extract an identifier code that is being displayed; and
a communication unit configured to receive payment information matching to the identifier code from a portable terminal, combining information extracted from the identifier code with the payment information, and send a request for payment approval to a payment service provider.

12. The apparatus of claim 11, wherein the communication unit is configured to receive a payment signal from the portable terminal.

13. The apparatus of claim 12, wherein the payment signal is a signal for extracting the identifier code to purchase goods or service associated with a broadcast of the broadcasting receiver.

14. The apparatus of claim 11, wherein the identifier code is a goods or service code that is being displayed in a region of the broadcasting receiver, wherein the goods or service code comprises at least one of a character code, an image code, a quick response (QR) code, and a bar code.

15. The apparatus of claim 14, wherein to extract the identifier code, the communication unit is configured to transmit the goods or service code to a server, and receive detailed information on goods or service from the server, the apparatus further comprising:
a display unit configured to display the detailed information.

16. The apparatus of claim 11, wherein the communication unit is configured to perform encrypted short-range communication with the portable terminal.

17. The apparatus of claim 16, wherein the payment information comprises card information of a user who performs short-range communication using the portable terminal.

18. The apparatus of claim 11, wherein the information extracted from the identifier code is detailed information on goods or service matching to the identifier code.

19. The apparatus of claim 18, wherein the detailed information on the goods or service comprises at least one of a price of the goods or service, a quantity, a sale period, and a discount condition.

20. The apparatus of claim 11, wherein the communication unit is configured to receive the payment approval result from a server, the apparatus further comprising:
a display unit for displaying the payment approval result.
